(19) United States
(12) Patent Application Publication
(10) Pub. No.: US 2007/0098034 A1
(43) Pub. Date: May 3, 2007

(54) Laser device

(75) Inventors: Masayuki Momiuchi, Itabashi-ku (JP); Yoshiaki Goto, Itabashi-ku (JP); Taizo Eno, Itabashi-ku (JP)

Correspondence Address: NIELDS & LEMACK, 176 EAST MAIN STREET, SUITE 7, WESTBORO, MA, 01581, US

(73) Assignee: Kabushiki Kaisha TOPCON

(21) Appl. No.: 11/583,541

(22) Filed: Oct. 19, 2006

(30) Foreign Application Priority Data
Oct. 28, 2005 (JP) 2005-315305

(51) Int. Cl. H01S 3/00

(52) U.S. Cl. 372/109

(57) ABSTRACT

A laser device which controls output of a laser oscillator based on a monitor light obtained by splitting a laser beam, comprising a luminous flux splitting means for reflecting the laser beam and for splitting as the monitor light, wherein a reflectivity R1 on a front surface and a reflectivity R2 on a rear surface are set so that interference between a reflected light on the front surface of the luminous flux splitting means and a reflected light on the rear surface of the luminous flux splitting means is suppressed.

### BACKGROUND OF THE INVENTION

The present invention relates to a laser device. In particular, the invention relates to a laser device for performing laser output control.

Referring to FIG. 5, description will be given on general features of a conventional type laser device for performing laser output control.

In FIG. 5, reference numeral 1 denotes a laser oscillator, numeral 2 denotes a driving device including a power source and a control unit, numeral 3 denotes luminous flux splitting means such as a plate glass (half-mirror), and numeral 4 represents a photodetector provided at a position opposite to the luminous flux splitting means 3.

The luminous flux splitting means 3 is arranged on an optical path of a laser beam 5 outputted from the laser oscillator 1 in such manner that the luminous flux splitting means 3 has a reflection surface of an angle of 45°. The luminous flux splitting means 3 reflects a part of the laser beam 5, e.g. 2%-5% of the laser beam 5 and transmits most part of the laser beam 5. The photodetector 4 receives a reflected light 6 (hereinafter referred as “monitor light 6”) reflected by the luminous flux splitting means 3, produces a photodetection intensity signal (a received light intensity signal)and outputs the photodetection intensity signal to the driving device 2.

The driving device 2 performs automatic power control (ATC) on the laser oscillator 1 so that light intensity of the monitor light 6 is turned to a constant level.

In case that the laser beam 5 is split by the luminous flux splitting means 3, as shown in FIG. 6, the laser beam 5 is reflected not only by the front surface S1 of the luminous flux splitting means 3 but also by the rear surface S2. A reflected light 6b reflected by the rear surface S2 has a longer optical path length compared with that of a reflected light 6a reflected by the front surface S1 by such difference in length that the reflected light 6b reciprocally runs over the plate thickness of the luminous flux splitting means 3. As a result, phase difference occurs between the reflected light 6a and the reflected light 6b, and interference takes place between the reflected light 6a and the reflected light 6b.

In case that the laser beam 5 enters under a constant condition, and in case that reflectivities on the front surface and on the rear surface are at constant values, the condition of interference is constant, and the ratio of the monitor light 6 to the laser beam 5 is also turned to a constant value. Thus, the laser beam can be controlled by automatic power control based on the monitor light 6.

However, incident condition of the laser beam 5 is not constant and the incident condition varies according to factors such as wavelength, temperature, etc. Thereby, reflectivity on the front surface differs from reflectivity on the rear surface and total reflectivity of the luminous flux splitting means 3 changes. As a result, the ratio of the monitor light 6 to the laser beam 5 also changes. Further, in case that an S linearly polarized light, a P linearly polarized light, and a circularly polarized light are present in mixed state in the laser beam 5, the reflectivity differs according to the condition of polarization. In case that the mixed ratio of the S linearly polarized light, the P linearly polarized light and the circularly polarized light changes, the total reflectivity also changes. As a result, the ratio of the monitor light 6 to the laser beam 5 also changes.

JP-A-9-258280 discloses a laser device, in which a part of an output light is split by a half-mirror and is monitored. Based on the results of the monitoring, a laser beam with a constant intensity is outputted. In the monitoring as described in JP-A-9-258280, no consideration is given on the reflection on the front surface and on the rear surface of the half-mirror as described above.

### SUMMARY OF THE INVENTION

It is an object of the present invention to provide a laser device, by which it is possible to perform accurate monitoring without fluctuation to an outputted laser beam and to perform output control of the laser beam with high accuracy.

To attain the above object, the present invention provides a laser device which controls output of a laser oscillator based on a monitor light obtained by splitting a laser beam, comprising a luminous flux splitting means for reflecting the laser beam and for splitting as the monitor light, wherein a reflectivity R1 on a front surface and a reflectivity R2 on a rear surface are set so that interference between a reflected light on the front surface of the luminous flux splitting means and a reflected light on the rear surface of the luminous flux splitting means is suppressed. Also, the present invention provides the laser device as described above, wherein the reflectivity R1 on the front surface of the luminous flux splitting means and the reflectivity R2 on the rear surface of the luminous flux splitting means are so arranged that R1<<R2 or R1>>R2. Further, the present invention provides the laser device as described above, wherein R1/R2 or R2/R1 is ⅓ or lower. Also, the present invention provides the laser device as described above, wherein the laser beam includes a P linearly polarized light and an S linearly polarized light, and incident angle of the laser beam to the luminous flux splitting means is set to about 10° or lower.

The present invention provides a laser device which controls output of a laser oscillator based on a monitor light obtained by splitting a laser beam, comprising a luminous flux splitting means for reflecting the laser beam and for splitting as the monitor light, wherein a reflectivity R1 on a front surface and a reflectivity R2 on a rear surface are set so that interference between a reflected light on the front surface of the luminous flux splitting means and a reflected light on the rear surface of the luminous flux splitting means is suppressed. As a result, fluctuation of the monitor light due to interference between the reflected light on the front surface and the reflected light on the rear surface is reduced, and accurate monitoring can be carried out. Also, it is possible to perform output control with high accuracy based on the monitor light.

Further, the present invention provides the laser device as described above, wherein the laser beam includes a P linearly polarized light and an S linearly polarized light, and incident angle of the laser beam to the luminous flux splitting means is set to about 10° or lower. Thus, fluctuation of the reflectivity on the luminous flux splitting means can be avoided when a P linearly polarized light and an S linearly polarized light are included in the laser beam.

### BRIEF DESCRIPTION OF THE DRAWINGS

FIG. 1 is a drawing to explain the principle of the present invention;

FIG. 2 is a diagram to show the relation of the intensity of a reflected light with amplitude reflectivities r1 and r2 in luminous flux splitting means;

FIG. 3 is a schematical drawing to show an example of the laser device, in which the present invention is carried out;

FIG. 4 is a diagram to show the relation between incident angle and reflectivity to correspond to polarized lights;

FIG. 5 is a schematical drawing to show a conventional example; and

FIG. 6 is a drawing to show conditions of the reflected light of the luminous flux splitting means in the conventional example.

### DETAILED DESCRIPTION OF THE PREFERRED EMBODIMENT

Description will be given below on the best mode for carrying out the present invention referring to the attached drawings.

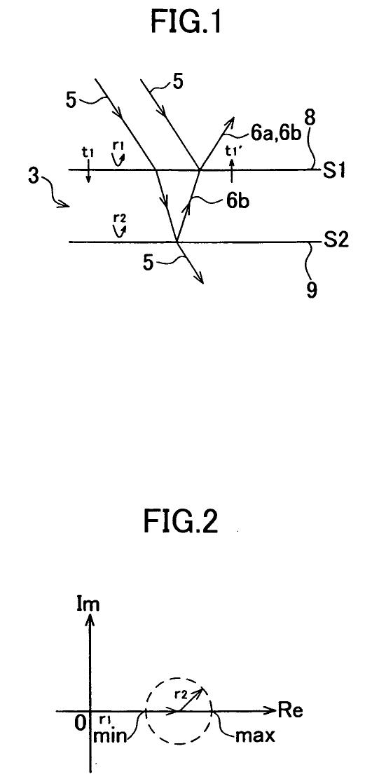

Referring to FIG. 1, description will be given below on the principle of the present invention. In FIG. 1, the same component as shown in FIG. 6 is referred by the same symbol.

On a front surface S1 of luminous flux splitting means 3 and on a rear surface S2 of the luminous flux splitting means 3, a first reflection preventive film 8 and a second reflection preventive film 9 are provided respectively.

FIG. 1 shows a case where consideration is given on reflection for one time only on the front surface S1 and on the rear surface S2 respectively. If it is supposed that amplitude reflectivities on the front surface S1 and on the rear surface S2 are r1 and r2 (r1²=Ri) respectively. Further, it is supposed that amplitude transmissivity at the entry to the front surface S1 including the first reflection preventive film 8 is t1, and that amplitude transmissivity at the time of exit is tl′, complex amplitude of a monitor light 6 is expressed by the following equation:
D=A·r1+A·t1·r2·tl′·e^{iΦ} (1)

Here, Φ=n·1·2π/λ.

Also, D is complex amplitude of a reflected light, A is complex amplitude of an incident light, n is refractive index of the luminous flux splitting means, l is optical path difference in the incident light 5, λ is a wavelength, and Φis a phase term.

If it is assumed that tl, tl′≈1, then intensity of the monitor light to monitor is given as:
|D|²=A²|r1+r2·e^{iΦ}|²

The amount of intensity change of the reflected light is determined by amplitude reflectivities r1 and r1.

The relation between the intensity of the reflected light and the amplitude reflectivities r1 and r2 is as shown in FIG. 2.

From FIG. 2,
Intensity of the reflected light (max): |r1+r2|²
Intensity of the reflected light (min): |r1−r2|²

Accordingly, in order to suppress interference between a reflected light 6a and a reflected light 6b and to reduce output fluctuation of the monitor light 6, a difference between the intensity (max) and the intensity (min) should be decreased.

Therefore, by setting the reflectivities of the first reflection preventive film 8 and the second reflection preventive film 9 to such values that R1<<R2 or R1>>R2 (where it is preferable that the value of R1/R2 or R2/R1 is from ≦⅓ to approximately a lower limit value), output fluctuation of the monitor light 6 can be reduced.

Now, description will be given below on concrete examples. For instance, in case the luminous flux splitting means 3 is glass and there is no reflection preventive film, reflectivities R1 and R2 of the front surface S1 and the rear surface R2 are in the range of 4% to 5% respectively (where r1 and r2 are 0.2 respectively). If it is supposed that R1 and R2 are 4% respectively,
Intensity of the reflected light (max): |r1+r2|²=|0.2+0.2|²=0.16
Intensity of the reflected light (min): |r1−r2|²=|0.2−0.2|²=0
Fluctuation range is: 0.16−0=0.16=16%.

On the other hand, if the reflection preventive film is provided on the front surface S1 and the reflectivity R1 is set to 0.5% (r1≈0.071),
Intensity of the reflected light (max): |r1+r2|²=|0.071+0.2|²=0.073
Intensity of the reflected light (min): |r1−r2|²=|0.071−0.2|²=0.017
Fluctuation range is: 0.073−0.017=0.056=5.6%.

Therefore, by providing the reflection preventive film only on one surface of the glass, the fluctuation range of the monitor light 6 can be extensively reduced.

Actually, it is desirable that the output of the laser beam 5 is increased. By setting either one of r1 or r2 of value closer to 0, total reflectivity is decreased, and output fluctuation of the monitor light 6 can be reduced.

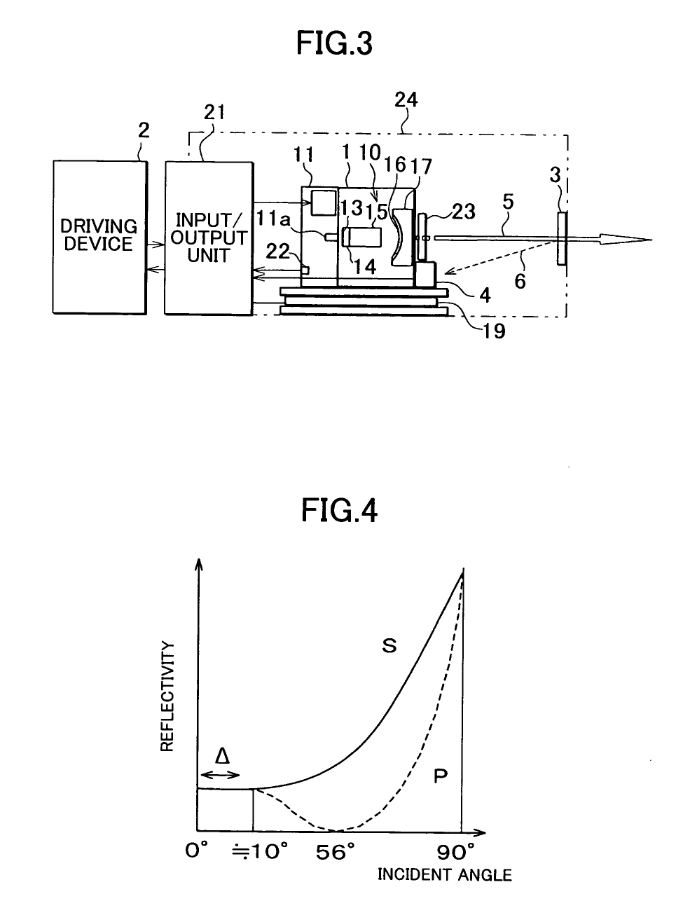

Next, referring to FIG. 3, description will be given on an example of the laser device, in which the present invention is applied.

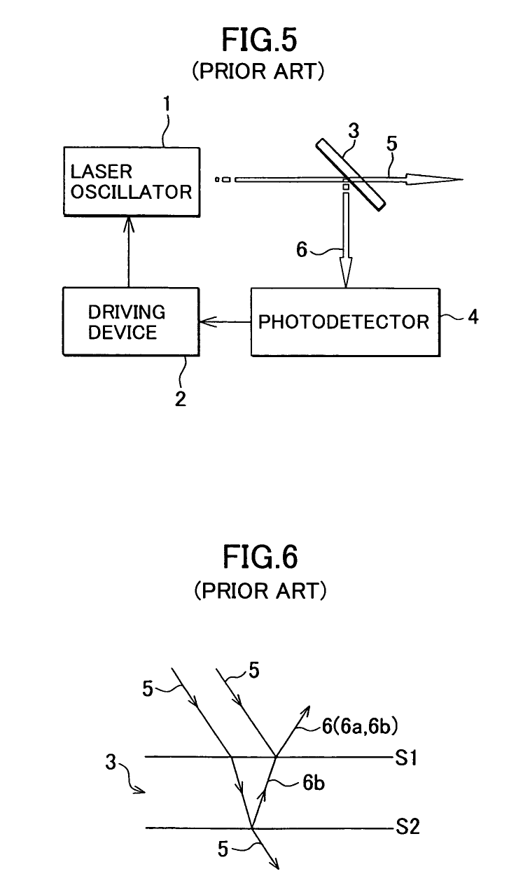

In FIG. 3, the same component as shown in FIG. 5 is referred by the same symbol.

First, description will be given on a laser oscillator 1.

The laser oscillator 1 is an LD oscillation solid-state laser of internal resonation type and SHG mode, which converts frequency of a laser beam from semiconductor laser. The laser oscillator 1 is provided with an LD light emitter 11 and with an optical resonator 10, which amplifies and outputs an excitation light emitted from the LD light emitter 11.

The optical resonator 10 comprises a laser crystal 14 on which a first dielectric reflection film 13 is formed, a nonlinear optical medium (NLO) 15, and a concave mirror 17 on which a second dielectric reflection film 16 is formed. At the optical resonator 10, the laser beam is pumped, resonated, amplified, and outputted. As the laser crystal 14, Nd:YVO₄ is used. As the nonlinear optical medium 15, KTP (KTiOPO₄; potassium titanyl phosphate) is used.

The LD light emitter 11 is used, for instance, to emit a linearly polarized laser beam with a wavelength of 809 nm as an excitation light, and a semiconductor laser 11a is used as a light emitting element. The laser emitting means is not limited to the semiconductor laser, and any type of laser emitting means may be adopted so far as it can emit a laser beam.

The laser crystal 14 is used to amplify a light. As the laser crystal 14, Nd:YVO₄ with an oscillation line of 1064 nm is used. In addition, YAG (yttrium aluminum garnet) doped with Nd³⁺ ion is used, and YAG has oscillation lines of 946 nm, 1064 nm, 1319 nm, etc. Ti (sapphire) with oscillation line of 700 nm to 900 nm can be used.

The first dielectric reflection film 13 is highly transmissive to a laser beam from the LD light emitter 11 and is highly reflective to an oscillation wave (fundamental wave) of the laser crystal 14. The first dielectric reflection film 13 is also highly reflective to a wavelength conversion light, e.g. a second harmonic wave (SHG: Second Harmonic Generation).

The concave mirror 17 is placed at a position opposite to the laser crystal 14. A surface of the concave mirror 17 closer to the laser crystal 14 is designed in a shape of a concave spherical mirror with an adequate radius, and a second dielectric reflection film 16 is formed on the concave mirror 17. The second dielectric reflection film 16 is highly reflective to an oscillation wave (fundamental wave) of the laser crystal 14, and the second dielectric reflection film 16 is highly transmissive to SHG.

As described above, when the first dielectric reflection film 13 of the laser crystal 14 and the second dielectric reflection film 16 of the concave mirror 17 are used together, and the laser beam from the LD light emitter 11 is pumped to the laser crystal 14 via a condenser lens (not shown), the light is reciprocally run between the first dielectric reflection film 13 of the laser crystal 14 and the second dielectric refection film 16. Thus, the light can be confined for long time, and the light can be resonated and amplified.

In the optical resonator 10, which comprises the first dielectric reflection film 13 of the laser crystal 14 and the concave mirror 17, the nonlinear optical medium 15 is placed. When an intense coherent light such as a laser beam enters the nonlinear optical medium 15, a second harmonic generation (SHG) to double the light frequency is generated. The generation of the second high harmonic is called “second harmonic generation”. Therefore, a laser beam with a wavelength of 532 nm is emitted from the laser oscillator 1.

In the laser oscillator 1 as described above, the nonlinear optical medium (hereinafter referred as “wavelength conversion element”) 15 is placed in the optical resonator 10, which comprises the laser crystal 14 and the concave mirror 17, and the wavelength conversion element 15 is called “internal type SHG”. Because conversion output is proportional to square of the excitation light power, it is possible to directly utilize high light intensity in the optical resonator.

The second harmonic wave (hereinafter referred as “wavelength conversion light”) generated at the wavelength conversion element 15 is projected from both end surfaces of the wavelength conversion element 15. One of end surfaces is the end surface closer to the concave mirror 17 and the other is the end surface closer to the laser crystal 14. The wavelength conversion light emitted from the end surface closer to the concave mirror 17 directly passes through the second dielectric reflection film 16 and the concave mirror 17 and is projected. The wavelength conversion light emitted from the end surface closer to the laser crystal 14 passes through the laser crystal 14 and is reflected by the first dielectric reflection film 13 and is projected through the laser crystal 14, the wavelength conversion element 15, the second dielectric reflection film 16, and the concave mirror 17.

Next, description will be given on the laser device provided with the laser oscillator 1.

The LD light emitter 11, the laser crystal 14, the nonlinear optical medium 15, the concave mirror 17, etc. are integrated with each other and make up together the laser oscillator 1, and this is installed in a chiller 19 such as a thermoelectric cooler (TEC).

A driving device 2 can drive and control the LD light emitter 11 and the chiller 19 via an input/output unit 21. A temperature sensor 22 is provided, which detects temperature of the LD light emitter 11, the laser crystal 14, and the nonlinear optical medium 15. The temperature sensor 22 and a photodetector (light receiver) 4 are connected to the driving device 2 via the input/output unit 21.

In FIG. 3, reference numeral 23 denotes a filter arranged opposite to the concave mirror 17. The filter 23 cuts off unnecessary excitation light leaking from the laser oscillator 1 and infrared light such as fundamental wave, and the filter 23 allows only SHG light to pass. Reference numeral 24 denotes a case. On a laser beam exit window of the case 24, the luminous flux splitting means 3 is arranged at a predetermined angle, e.g. at an angle of about 10° or lower with respect to the optical path so that the monitor light 6 reflected by the luminous flux splitting means 3 enters the photodetector 4.

The excitation light emitted from the semiconductor laser 11a is converted to a fundamental light by the laser crystal 14. Wavelength of the fundamental light is converted by the nonlinear optical medium 15, and a wavelength conversion light is generated. A part of the wavelength conversion light is projected from an end surface of the nonlinear optical medium 15 closer to the second dielectric reflection film 16 through the second dielectric reflection film 16 directly. The remaining part of the wavelength conversion light passes through the laser crystal 14 and is reflected by the first dielectric reflection film 13. Then, the remaining part of the wavelength conversion light passes through the nonlinear optical medium 15 and is projected through the second dielectric reflection film 16. Because the laser crystal 14 has an effect as a wave plate, when the remaining part of the wavelength conversion light passes through the laser crystal 14, the remaining part of the projected wave length conversion light is turned to an elliptically polarized light including a P linearly polarized light component and an S linearly polarized light component.

A part of the wavelength conversion light (laser beam 5) emitted from the laser oscillator 1 is reflected by the luminous flux splitting means 3. The monitor light 6 reflected by the luminous flux splitting means 3 is received by the photodetector 4, and a photodetection signal is sent to the driving device 2 via the input/output unit 21. Based on the photodetection signal, the driving device 2 controls the output of the LD light emitter 11 via the input/output unit 21. Temperature of each of the LD light emitter 11, the laser crystal 14, and the nonlinear optical medium 15 is detected by the temperature sensor 22. Based on the temperature detected by the temperature sensor 22, the chiller 19 is driven and controlled via the input/output unit 21, and chilling is performed so that the LD light emitter, the laser crystal 14, and the nonlinear optical medium 15 are maintained at a predetermined temperature.

The laser beam 5 is turned to an elliptically polarized light. Because the wave plate effect of the laser crystal 14 is changed according to the temperature of the laser crystal 14, the ratio of the P linearly polarized light component and the S linearly polarized light component are also changed.

The P linearly polarized light and the S linearly polarized light have such property that reflectivity is changed respectively due to incident angle to the reflection surface. FIG. 4 shows the changes of reflectivity to match the change of the incident angle of the P linearly polarized light and the S linearly polarized light. From FIG. 4, it is evident that the reflectivity is approximately at a constant level when incident angles of the P linearly polarized light and the S linearly polarized light are in the range of 0° to about 10°. In the S linearly polarized light, reflectivity is gradually increased up to the incident angle of 90°. In the P linearly polarized light, reflectivity is decreased up to the incident angle of about 56°. When the incident angle is about 56°, the reflectivity is turned to about 0°. Thereafter, reflectivity increases until the incident angle reaches 90°. When the incident angle is 90°, the reflectivity of the S linearly polarized light is equalized to the reflectivity of the P linear polarized light.

In the laser device of the present invention, for the purpose of avoiding fluctuation of the reflectivity at the luminous flux splitting means 3 when the P linearly polarized light and the S linearly polarized light are present mixed in the laser beam 5, it is so arranged that the incident angle of the laser beam 5 to the luminous flux splitting means 3 is set to a smaller value, e.g. to an angle of about 10° or lower.

When the incident angle is set to a smaller value, interference occurs much easier between the reflected light 6a on the front surface Si of the luminous flux splitting means 3 of the laser beam 5 and the reflected light 6b on the rear surface S2, and problem arises that total reflectivity of the monitor light 6 is fluctuated due to the interference.

As described above, according to the present invention, the reflectivity R1 on the front surface S1 and the reflectivity R2 on the rear surface S2 are set to such values that R1<<R2 or R1>>R2. As a result, total reflectivity fluctuation due to the interference can be reduced, and it is possible to perform output control of the laser beam with high accuracy.

What is claimed is:

1. A laser device which controls output of a laser oscillator based on a monitor light obtained by splitting a laser beam, comprising a luminous flux splitting means for reflecting the laser beam and for splitting as the monitor light, wherein a reflectivity R1 on a front surface and a reflectivity R2 on a rear surface are set so that interference between a reflected light on the front surface of said luminous flux splitting means and a reflected light on the rear surface of said luminous flux splitting means is suppressed.

2. A laser device according to claim 1, wherein the reflectivity R1 on the front surface of said luminous flux splitting means and the reflectivity R2 on the rear surface of the luminous flux splitting means are so arranged that R1<<R2 or R1>>R2.

3. A laser device according to claim 1, wherein R1/R2 or R2/R1 is ⅓ or lower.

4. A laser device according to claim 1, wherein said laser beam includes a P linearly polarized light and an S linearly polarized light, and incident angle of the laser beam to said luminous flux splitting means is set to about 10° or lower.
